(19) United States
(12) Patent Application Publication
(10) Pub. No.: US 2025/0299004 A1
(43) Pub. Date: Sep. 25, 2025

(54) INFORMATION PROCESSING APPARATUS, METHOD FOR CONTROLLING INFORMATION PROCESSING APPARATUS, AND STORAGE MEDIUM

(71) Applicant: SEIKO EPSON CORPORATION, Tokyo (JP)

(72) Inventor: Yoshinori OSHIMA, Aizuwakamatsu-shi (JP)

(73) Assignee: SEIKO EPSON CORPORATION, Tokyo (JP)

(21) Appl. No.: 19/082,402

(22) Filed: Mar. 18, 2025

(30) Foreign Application Priority Data
Mar. 19, 2024 (JP) 2024-043233

(51) Int. Cl. G06K 15/02; G06K 15/00

(52) U.S. Cl. CPC G06K 15/022; G06K 15/1843; G06K 15/186; G06K 15/4065

(57) ABSTRACT

An information processing apparatus includes an acquirer configured to acquire printing tape width information; a storage storing a plurality of pieces of image data for which respective corresponding tape widths are predefined, and a generator configured to generate continuous print data for continuous printing of two or more print images. When the corresponding tape width predefined for at least one piece of image data among the two or more pieces of image data to be used for the continuous printing differs from the printing tape width, the generator is configured to convert the at least one piece of image data with the corresponding tape width different from the printing tape width into modified image data in which an image size is adjusted to match the printing tape width, and to generate the continuous print data based on the two or more pieces of image data including the modified image data.

The present application is based on, and claims priority from JP Application Serial Number 2024-043233, filed Mar. 19, 2024, the disclosure of which is hereby incorporated by reference herein in its entirety.

### BACKGROUND

### 1. Technical Field

The present disclosure relates to an information processing apparatus, a method for controlling an information processing apparatus, and a storage medium.

### 2. Related Art

As disclosed in JP-A-09-066632, a known tape printing apparatus includes a storage that stores a plurality of pieces of image data, a receiving section that receives a selection of image data to be printed from among the plurality of pieces of image data stored in the storage, and a printing section that prints, on a tape, a print image corresponding to the image data the selection of which is received. In addition, there is a known tape printing apparatus that can perform continuous printing to continuously print a plurality of print images on a tape.

In some existing tape printing apparatuses, a storage stores a plurality of pieces of image data with the corresponding tape widths predefined. In such tape printing apparatuses, when print images are continuously printed, the print images are printed in sizes that correspond to the predefined tape widths for the plurality of pieces of image data. Therefore, in the existing tape printing apparatuses, when continuous printing is performed for the plurality of pieces of image data with different tape widths, print images having different image sizes are continuously printed. Additionally, in the existing tape printing apparatuses, if an image data's predefined tape width exceeds the tape width of the tape being used in the tape printing apparatus, continuous printing of the image data may result in a print image where portions are missing.

### SUMMARY

According to an aspect of the present disclosure, an information processing apparatus includes an acquirer configured to acquire printing tape width information indicating a printing tape width that is a width of a tape used in a tape printing apparatus; a storage storing a plurality of pieces of image data for which respective corresponding tape widths are predefined; and a generator configured to generate continuous print data for continuous printing of two or more print images respectively corresponding to two or more pieces of image data, among the plurality of pieces of image data stored in the storage, on the tape with the printing tape width indicated by the printing tape width information. When the corresponding tape width predefined for at least one piece of image data among the two or more pieces of image data to be used for the continuous printing differs from the printing tape width, the generator is configured to convert the at least one piece of image data with the corresponding tape width different from the printing tape width into modified image data in which an image size is adjusted to match the printing tape width, and to generate the continuous print data based on the two or more pieces of image data including the modified image data.

According to an aspect of the present disclosure, a method for controlling an information processing apparatus being performed by the information processing apparatus, the method includes acquiring printing tape width information indicating a printing tape width that is a width of a tape used in the tape printing apparatus; and generating continuous print data for continuous printing, on the tape with the printing tape width indicated by the printing tape width information, of two or more print images respectively corresponding to two or more pieces of image data among a plurality of pieces of image data stored in a storage storing the plurality of pieces of image data for which respective corresponding tape widths are predefined. In the method, the generating the continuous print data includes, when the corresponding tape width predefined for at least one piece of image data among the two or more pieces of image data to be used for the continuous printing differs from the printing tape width, converting the at least one piece of image data with the corresponding tape width different from the printing tape width into modified image data in which an image size is adjusted to match the printing tape width, and generating the continuous print data based on the two or more pieces of image data including the modified image data.

According to an aspect of the present disclosure, a non-transitory computer-readable storage medium storing a program that causes an information processing apparatus to execute a process, the process comprising: acquiring printing tape width information indicating a printing tape width that is a width of a tape used in a tape printing apparatus; and generating continuous print data for continuous printing, on the tape with the printing tape width indicated by the printing tape width information, of two or more print images respectively corresponding to two or more pieces of image data among a plurality of pieces of image data stored in a storage storing the plurality of pieces of image data for which respective corresponding tape widths are predefined. The generating the continuous print data includes, when the corresponding tape width predefined for at least one piece of image data, among the two or more pieces of image data to be used for the continuous printing, differs from the printing tape width, converting the at least one piece of image data with the corresponding tape width different from the printing tape width into modified image data in which an image size is adjusted to match the printing tape width, and generating the continuous print data based on the two or more pieces of image data including the modified image data.

### BRIEF DESCRIPTION OF THE DRAWINGS

FIG. 1 is a system configuration diagram of a tape printing system.

FIG. 2 is a table illustrating exemplary image data stored in an image data storage area.

FIG. 3 illustrates an exemplary print result of a continuous print image.

FIG. 4 illustrates an exemplary printed result of a continuous print image when an automatic image resize function is set to valid.

FIG. 5 is a pictorial illustration of a tape printing apparatus and a tape cartridge.

FIG. 6 is a block diagram illustrating a hardware configuration of the portable terminal and the tape printing apparatus.

FIG. 7 is a block diagram illustrating a functional configuration of the portable terminal.

FIG. 8 illustrates an exemplary image data display screen.

FIG. 9 illustrates an exemplary image data selection screen.

FIG. 10 illustrates an exemplary image data selection screen different from that of FIG. 9.

FIG. 11 illustrates an exemplary printed result of a continuous print image when the automatic image resize function is set to valid.

FIG. 12 illustrates an exemplary printed result of a continuous print image when the automatic image resize function is set to invalid.

FIG. 13 is a flowchart illustrating a print data transmission process performed by the portable terminal.

FIG. 14 illustrates an exemplary image data selection screen according to a modification.

FIG. 15 illustrates an exemplary printed result of a continuous print image when the automatic image resize function is not applied to some of a plurality of pieces of image data to be used for continuous printing.

FIG. 16 illustrates an exemplary image data selection screen according to a modification different from the modification in FIG. 14.

FIG. 17 illustrates another exemplary printed result of a continuous print image when the automatic image resize function is set to invalid.

### DESCRIPTION OF EMBODIMENTS

Hereafter, an information processing apparatus, a method for controlling an information processing apparatus, and a storage medium will be described with reference to the accompanying drawings. Some drawings will be described using directions based on an XYZ orthogonal coordinate system for convenience, but these directions do not restrict the following embodiments.

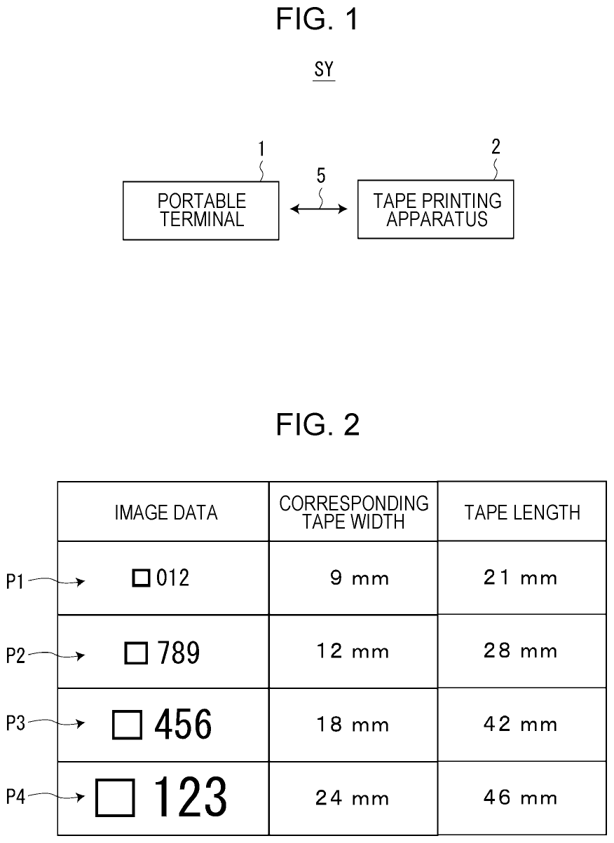

FIG. 1 illustrates a system configuration diagram of a tape printing system SY. The tape printing system SY includes a portable terminal 1 and a tape printing apparatus 2, which are communicatively connected via a communication path 5 using wireless communication. The portable terminal 1 is an exemplary information processing apparatus. The communication path 5 may use a cable or a wired network instead of wireless communication.

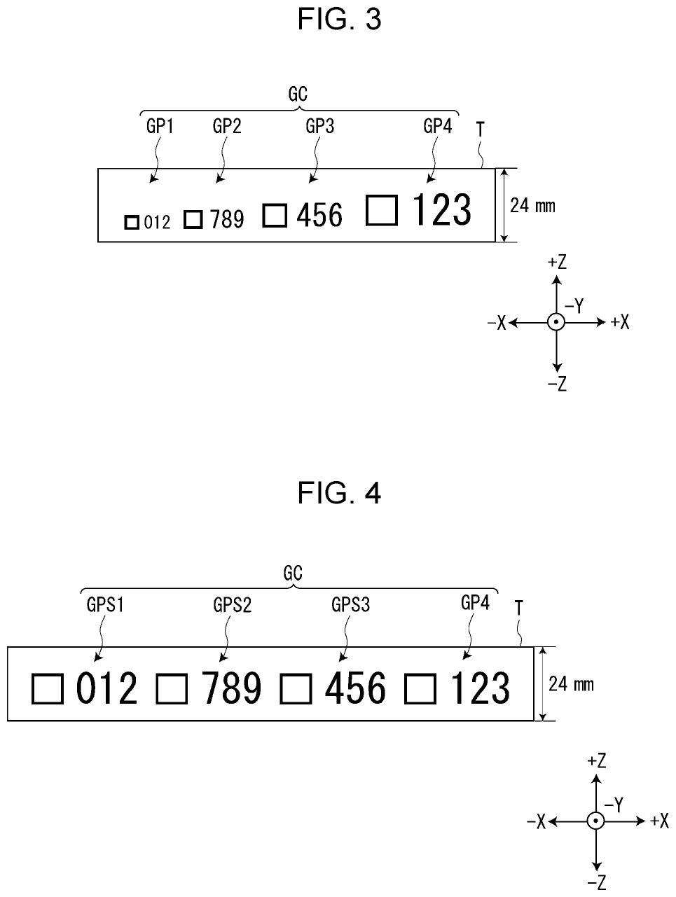

The portable terminal 1 generates print data for printing print images GP1 to GP4, which constitutes a print image GC, on a tape T, as illustrated in FIG. 3, and transmits the generated print data to the tape printing apparatus 2. The print images GP1 to GP4 and GC are collectively referred to as a print image G or print images G when no distinction is made between them. For instance, the portable terminal 1 generates raster data as the print data.

The tape printing apparatus 2 prints the print image G onto the tape T based on the print data transmitted from the portable terminal 1. Additionally, the portable terminal 1 can generate continuous print data that is print data for continuously printing a plurality of print images G on the tape T. Upon receiving the continuous print data from the portable terminal 1, the tape printing apparatus 2 prints continuous print image GC on the tape T based on the continuous print data. In the following description, the individual print images G within the continuous print image GC are referred to as individual print images GP1 through GP4. The individual print images GP1 trough GP4 are collectively referred to as an individual print image GP or individual print images GP when no distinction is made between them.

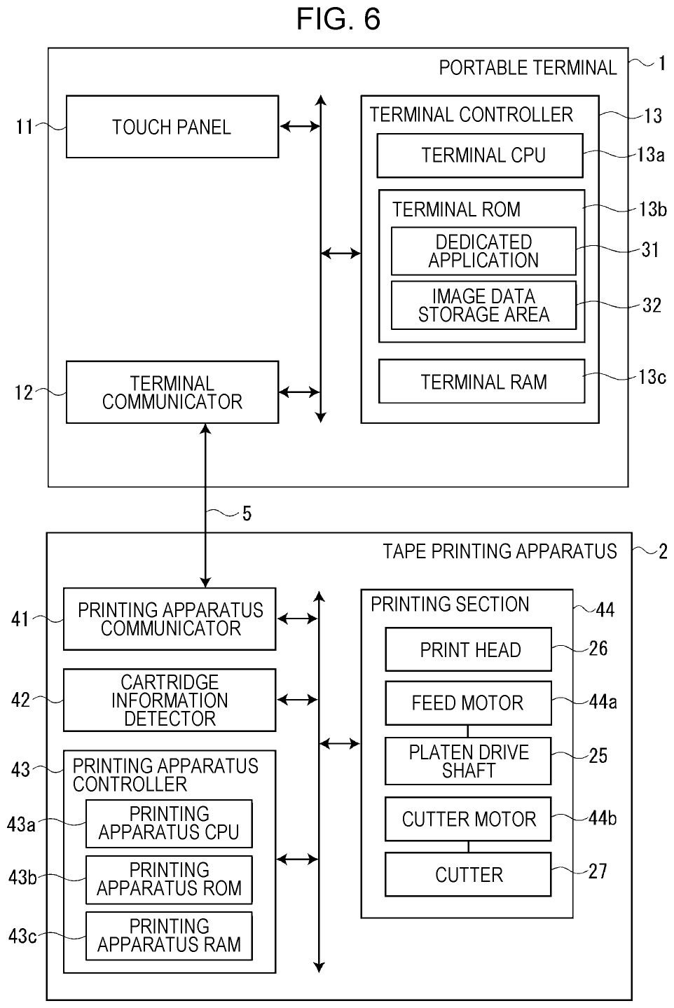

Using an edit screen (not illustrated), the portable terminal 1 can receive input to either edit new print data or read and edit the pre-stored image data P1 to P4 illustrated in FIG. 2. The image data P1 to the image data P4 are collectively referred to as image data P when no distinction is made between them. When the user chooses to read and edit the image data P, the portable terminal 1 reads a plurality of pieces of image data from an image data storage area 32 illustrated in FIG. 6, which will be described later, and generates continuous print data based on the plurality of pieces of read image data. The image data storage area 32 is an exemplary storage. For a plurality of pieces of image data stored in the image data storage area 32, respective corresponding tape widths are predefined.

FIG. 2 is a table illustrating exemplary image data P stored in the image data storage area 32. In the example illustrated in FIG. 2, four pieces of image data P that is, first image data P1 to fourth image data P4, are stored. For example, in FIG. 2, the corresponding tape width for the first image data P1 is set to 9 mm. That is, the first image data P1 assumes that printing will be performed on the tape T with a width of 9 mm. Additionally, in the example illustrated in FIG. 2, a tape length of 21 mm is specified for the first image data P1.

FIG. 3 illustrates a printed result when the continuous print image GC, including the four individual print images GP corresponding to the four pieces of image data P illustrated in FIG. 2, is printed on the tape T with a width of 24 mm. In FIG. 3, the first individual print image GP1, the second individual print image GP2, the third individual print image GP3, and the fourth individual print image GP4 are print images G corresponding to the first image data P1, the second image data P2, the third image data P3, and the fourth image data P4, respectively.

Accordingly, when the individual print images GP corresponding to the image data P are continuously printed, they are printed in image sizes that match the corresponding tape widths predefined for the image data P. That is, when a plurality of pieces of image data P with different corresponding tape widths are continuously printed, the resulting individual print images GP will have different image sizes.

Therefore, in the tape printing system SY according to the present embodiment, the image size of the individual print image GP may be automatically adjusted to match the width of the tape T used in the tape printing apparatus 2. The width of the tape T used in the tape printing apparatus 2 will hereafter be referred to as a printing tape width. Specifically, if the corresponding tape width set for at least one piece of image data P to be used for continuous printing differs from the printing tape width, the portable terminal 1 converts the image data P with the corresponding tape width different from the printing tape width into modified image data in which the image size is adjusted to match the printing tape width. The portable terminal 1 then generates continuous print data for enabling the tape printing apparatus 2 to print the continuous print image GC, based on the plurality of pieces of image data P including the modified image data.

FIG. 4 illustrates a continuous print image GC that is printed based on the continuous print data generated in this way. In the example illustrated in FIG. 4, since the fourth individual print image GP4 has the tape width of 24 mm set for the corresponding fourth image data P4, which is the same as the printing tape width, the image size of the fourth individual print image GP4 is not adjusted to match the printing tape width. In contrast, the three individual print images GP other than the fourth individual print image GP4 are the individual print images GP printed based on modified image data (not illustrated) in which the image size is adjusted to match the printing tape width. The individual print images GP printed based on the modified image data will hereafter be referred to as modified individual print images GPS1 to GPS3. The modified individual print images GPS1 to GPS3 are collectively referred to as a modified individual print image GPS or modified individual print images GPS when no distinction is made between them.

Accordingly, in the tape printing system SY, even when a plurality of pieces of image data P with different corresponding tape widths are continuously printed, the individual print images GP having an image size adjusted to match the printing tape width may be continuously printed.

The portable terminal 1 can receive, for the image data P with which the corresponding tape width different from the printing tape width is associated, the setting of whether or not to automatically adjust the image size to match the printing tape width. The function of automatically adjusting the image size to match the printing tape width will be hereafter referred to as an automatic image resize function.

If the automatic image resize function is set to valid, the portable terminal 1 converts the image data P, where the corresponding tape width differs from the printing tape width, into modified image data. In this case, when the continuous print image GC, including the four individual print images GP corresponding to the four pieces of image data P illustrated in FIG. 2, is printed on the tape T with a width of 24 mm, the printed result will appear as illustrated in FIG. 4. In contrast, if the automatic image resize function is set to invalid, the portable terminal 1 does not convert such image data P into modified image data. In this case, when the continuous print image GC including the four individual print images GP corresponding to the four pieces of image data P illustrated in FIG. 2 is printed on the tape T with the width of 24 mm, the printed result will appear as illustrated in FIG. 3.

The image data P is vector data, for example. The portable terminal 1 generates, for the image data P, modified image data not only by resizing the image of the image data P to match the printing tape width but also by adjusting the layout of the image data P to match the printing tape width. Accordingly, using vector data for the image data P can reduce a decrease in image quality caused by resizing the image or adjusting the layout.

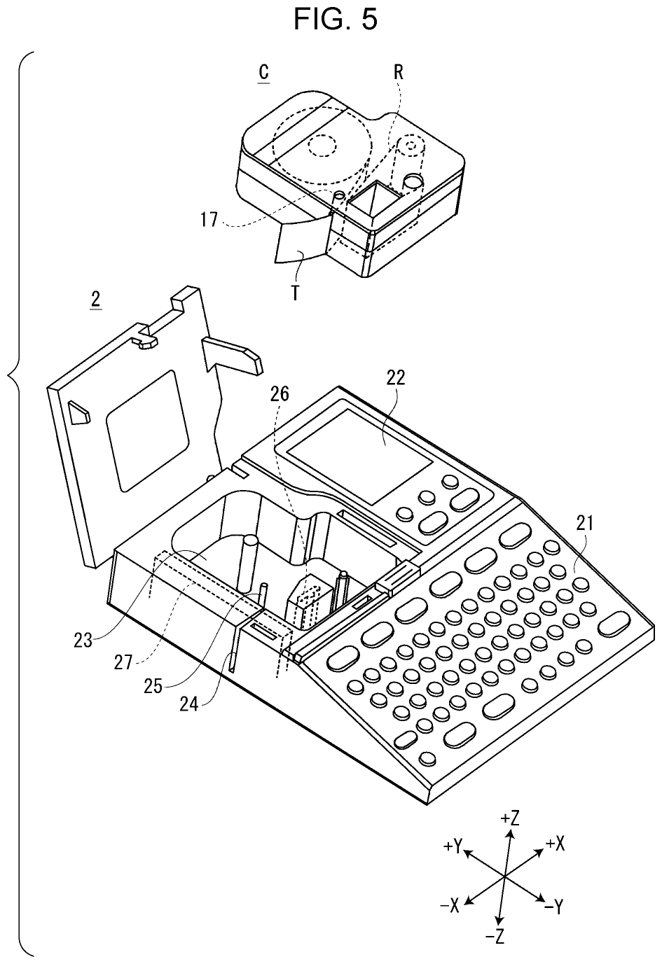

FIG. 5 is a pictorial illustration of the tape printing apparatus 2 and a tape cartridge C. The tape printing apparatus 2 includes an operation key group 21, a printing apparatus display 22, a cartridge mounting portion 23, and a tape outlet 24.

The operation key group 21 and the printing apparatus display 22 are mainly used when the tape printing apparatus 2 operates in a stand-alone manner. A detailed description of these components is omitted since it is assumed in the present embodiment that the tape printing apparatus 2 operates while connected to the portable terminal 1.

The tape cartridge C is detachably mounted in the cartridge mounting portion 23. In the tape cartridge C, a tape T and an ink ribbon R are accommodated in a wound state inside the case. In the tape cartridge C, a platen roller 17 is also included.

In the cartridge mounting portion 23, a platen drive shaft 25 and a print head 26 are provided. The platen roller 17 is engaged with the platen drive shaft 25 while the tape cartridge C is mounted in the cartridge mounting portion 23. The platen roller 17 feeds the tape T and the ink ribbon R in the −X direction.

The print head 26 is disposed at a location facing the platen roller 17 while the tape cartridge C is mounted in the cartridge mounting portion 23. The print head 26 is driven to generate heat in accordance with print data transmitted from the portable terminal 1. As a result, the ink of the ink ribbon R is transferred onto the tape T, such that the print image G based on the print data is printed on the tape T.

A cutter 27 is provided between the cartridge mounting portion 23 and the tape outlet 24. The cutter 27 cuts the printed tape T in the Z-axis direction. The cut tape T exits from the tape outlet 24.

FIG. 6 illustrates a hardware configuration of the portable terminal 1 and the tape printing apparatus 2. The portable terminal 1 includes a touch panel 11, a terminal communicator 12, and a terminal controller 13. The touch panel 11 is an exemplary display. Additionally, the terminal communicator 12 is an exemplary communicator.

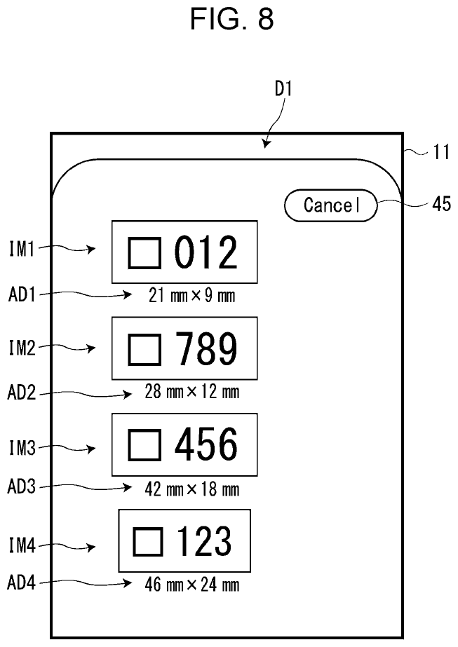

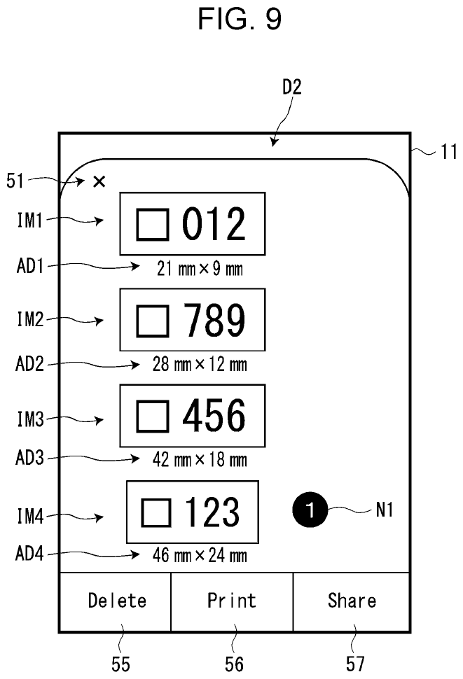

The touch panel 11 functions as a display unit that displays various screens, such as an image data display screen D1 illustrated in FIG. 8 and an image data selection screen D2 illustrated in FIG. 9, which will be described later. The touch panel 11 also functions as an operation unit for a user to perform various operations.

The terminal communicator 12 communicates with the tape printing apparatus 2 via the communication path 5. For example, the terminal communicator 12 transmits print data to the tape printing apparatus 2 and receives cartridge information, which is information about the tape cartridge C, from the tape printing apparatus 2. The cartridge information includes printing tape width information indicating the printing tape width of the tape T accommodated in the tape cartridge C.

The terminal controller 13 includes a terminal central processing unit (CPU) 13a, a terminal read-only memory (ROM) 13b, and a terminal random access memory (RAM) 13c.

The terminal ROM 13b is a rewritable ROM and stores a dedicated application 31. The dedicated application 31 is an exemplary program. The dedicated application 31 is an application program for generating print data and communicating with the tape printing apparatus 2. The dedicated application 31 is downloaded, for example, as a smartphone application from a server (not illustrated) to the portable terminal 1 and is installed in the portable terminal 1.

Additionally, the terminal ROM 13b includes the image data storage area 32. As described above, the image data storage area 32 stores the plurality of image data P for which corresponding tape widths are set, which are illustrated in FIG. 2.

The terminal CPU 13a performs various types of control by loading a program, such as the dedicated application 31, stored in the terminal ROM 13b into the terminal RAM 13c and executing the program. The terminal controller 13 may use a hardware circuit, such as an application specific integrated circuit (ASIC), instead of the terminal CPU 13a, as the processor. Additionally, the processor may have a configuration in which one or more CPUs and a hardware circuit, such as an ASIC, operate in cooperation with each other.

The tape printing apparatus 2 includes a printing apparatus communicator 41, a cartridge information detector 42, a printing apparatus controller 43, and a printing section 44.

The printing apparatus communicator 41 communicates with the portable terminal 1 via the communication path 5.

The cartridge information detector 42 optically detects cartridge information from a code image provided on the exterior surface of the tape cartridge C mounted in the cartridge mounting portion 23. The cartridge information detector 42 may detect the cartridge information from a circuit board or a radio-frequency identification (RFID) tag in the tape cartridge C.

The printing apparatus controller 43 includes a printing apparatus CPU 43a, a printing apparatus ROM 43b, and a printing apparatus RAM 43c.

The printing apparatus ROM 43b stores a control program such as firmware. The printing apparatus CPU 43a performs various kinds of control by loading a control program, such as firmware, stored in the printing apparatus ROM 43b into the printing apparatus RAM 43c and executing the control program. The printing apparatus controller 43 may use a hardware circuit, such as an ASIC, instead of the printing apparatus CPU 43a, as the processor. Additionally, the processor may have a configuration in which one or more CPUs and a hardware circuit, such as an ASIC, operate in cooperation with each other.

Upon acquiring print data from the portable terminal 1, the printing apparatus CPU 43a causes the printing section 44 described later to perform printing. Additionally, upon receiving a cartridge information request signal from the portable terminal 1, the printing apparatus CPU 43a transmits cartridge information detected by the cartridge information detector 42 to the portable terminal 1.

The printing section 44 is a mechanism for performing printing on the tape T, and includes the print head 26, a feed motor 44a, the platen drive shaft 25, a cutter motor 44b, and the cutter 27.

The print head 26 includes a plurality of heating elements and performs printing by thermally transferring ink from the ink ribbon R to the tape T. The feed motor 44a is a drive source that drives the platen drive shaft 25. The feed motor 44a feeds the tape T and the ink ribbon R in the −X direction by rotating the platen roller 17 via the platen drive shaft 25. The cutter motor 44b is a drive source that drives the cutter 27. The cutter motor 44b cuts the tape T in the Z-axis direction by driving the cutter 27.

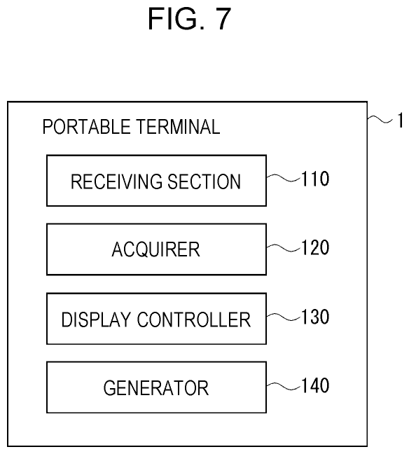

FIG. 7 is a block diagram illustrating a functional configuration of the portable terminal 1. The portable terminal 1 includes a receiving section 110, an acquirer 120, a display controller 130, and a generator 140. These functions are implemented by the terminal CPU 13a executing the dedicated application 31.

The receiving section 110 receives selection of two or more pieces of image data P to be used for continuous printing from among a plurality of pieces of image data P stored in the image data storage area 32.

The acquirer 120 acquires printing tape width information indicating a printing tape width, which is the width of the tape T used in the tape printing apparatus 2. As described above, the printing tape width information is transmitted from the tape printing apparatus 2. The acquirer 120 acquires the printing tape width information received by the terminal communicator 12.

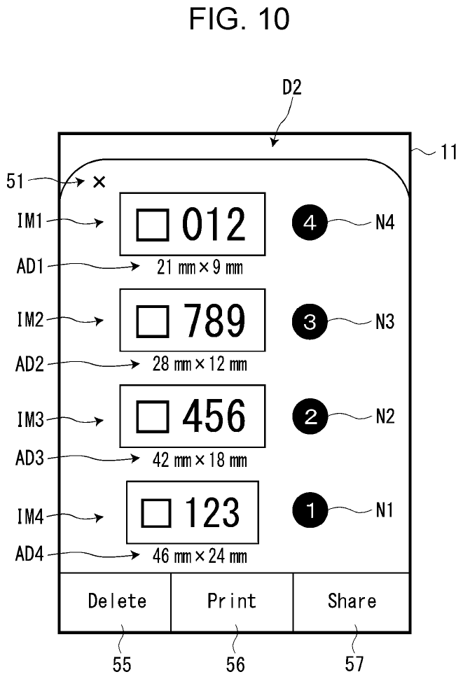

As illustrated in FIG. 10, the display controller 130 causes the touch panel 11 to display a plurality of printed image thumbnails IM1 to IM4 corresponding to a plurality of respective pieces of image data P to be used for continuous printing. The printed image thumbnails IM1 to IM4 are collectively referred to as a printed image thumbnail IM or printed image thumbnails IM when no distinction is made between them. Additionally, the display controller 130 causes the touch panel 11 to display pieces of order information N1 to N4, which indicate the order in which the selection of the image data P is received by the receiving section 110, on the touch panel such that each piece of the order information N1 to N4 is associated with a respective one of the plurality of printed image thumbnails IM. The pieces of order information N1 to N4 are collectively referred to as order information N when no distinction is made between them.

The generator 140 generates continuous print data for continuously printing two or more individual print images GP respectively corresponding to two or more pieces of image data P the selection of which has been received by the receiving section 110, among the plurality of pieces of image data P stored in the image data storage area 32, on the tape T with the printing tape width indicated by the printing tape width information. Additionally, the generator 140 generates the continuous print data such that two or more individual print images GP corresponding to two or more pieces of image data P are continuously printed in the order in which the selection of the image data P is received by the receiving section 110.

When the automatic image resize function is set to valid, the generator 140 converts the image data P with the corresponding tape width different from the printing tape width, among the two or more pieces of image data P to be used for continuous printing, into the modified image data in which the image size is adjusted to match the printing tape width. Then, the generator 140 generates continuous print data based on the two or more image data P including the modified image data as a conversion result.

Screens displayed on the touch panel 11 will be described with reference to FIGS. 8 to 10. FIG. 8 illustrates an example of the image data display screen D1. The image data display screen D1 is a screen displayed when an instruction is provided on an edit screen (not illustrated) to generate print data by using the image data P read from the image data storage area 32.

On the image data display screen D1, a printed image thumbnail IM, additional information AD, and a cancel button 45 are displayed. In response to selection of the cancel button 45, the portable terminal 1 hides the image data display screen D1 and displays the edit screen on the touch panel 11.

The portable terminal 1 displays, as the printed image thumbnails IM, a plurality of printed image thumbnails IM respectively corresponding to a plurality of pieces of image data P stored in the image data storage area 32. The example illustrated in FIG. 8 indicates an example of the image data display screen D1 displayed when the image data P illustrated in FIG. 2 is stored in the image data storage area 32. In FIG. 8, a first printed image thumbnail IM1, a second printed image thumbnail IM2, a third printed image thumbnail IM3, and a fourth printed image thumbnail IM4 are printed image thumbnails IM corresponding to the first image data P1, the second image data P2, the third image data P3, and the fourth image data P4 illustrated in FIG. 2, respectively.

The printed image thumbnails IM having substantially the same tape width, without in accordance with the corresponding tape widths set for the respective pieces of corresponding image data P, are displayed on the image data display screen D1 In addition, each of the printed image thumbnails IM is displayed with additional information AD added thereto. The additional information AD is information indicating the tape length of the image data P corresponding to the added printed image thumbnail IM and the corresponding tape width. For example, first additional information AD1 added to the first printed image thumbnail IM1 indicates that the tape length is 21 mm and the corresponding tape width is 9 mm.

FIG. 9 illustrates an example of the image data selection screen D2. The image data selection screen D2 is a screen displayed when a selection operation is performed on any one of the printed image thumbnails IM displayed on the image data display screen D1. On the image data display screen D1, the selection operation is performed, for example, by long pressing the printed image thumbnail IM.

On the image data selection screen D2, in addition to the printed image thumbnail IM and the additional information AD displayed on the image data display screen D1, order information N, a close icon 51, a delete button 55, a print button 56, and a share button 57 are displayed. When the close icon 51 is selected, the portable terminal 1 hides the image data selection screen D2 and displays the image data display screen D1 on the touch panel 11.

The example illustrated in FIG. 9 illustrates the image data selection screen D2 displayed when a selection operation is performed on the fourth printed image thumbnail IM4 on the image data display screen D1 illustrated in FIG. 8. Therefore, on the image data selection screen D2 illustrated in FIG. 9, the first order information N1, which is the order information N indicating the number 1, is displayed in association with the fourth printed image thumbnail IM4. The first order information N1 indicates that the image data P corresponding to the printed image thumbnail IM associated with the first order information N1 is the image data P first selected.

The delete button 55 is a button for deleting the image data P corresponding to the printed image thumbnail IM being selected. When the delete button 55 is selected, the portable terminal 1 deletes the image data P corresponding to the printed image thumbnail IM associated with the order information N from the image data storage area 32.

The print button 56 is a button for issuing a print instruction. For example, when the print button 56 is selected in the state illustrated in FIG. 9, the portable terminal 1 transmits the image data P corresponding to the printed image thumbnail IM associated with the order information N to the tape printing apparatus 2.

The share button 57 is a button for sharing the image data P corresponding to the printed image thumbnail IM being selected with another person. When the share button 57 is selected, the portable terminal 1 attaches the image data P corresponding to the printed image thumbnail IM associated with the order information N to an e-mail, as an attached file, and transmits the e-mail to a destination designated by the user.

The image data selection screen D2 illustrated in FIG. 10 indicates a display example when the third printed image thumbnail IM3, the second printed image thumbnail IM2, and the first printed image thumbnail IM1 are continuously selected on the image data selection screen D2 illustrated in FIG. 9. Therefore, in the example illustrated in FIG. 10, the second order information N2 indicating the number 2 is displayed in association with the third printed image thumbnail IM3, the third order information N3 indicating the number 3 is displayed in association with the second printed image thumbnail IM2, and the fourth order information N4 indicating the number 4 is displayed in association with the first printed image thumbnail IM1. On the image data selection screen D2, a selection operation is performed, for example, by short pressing the printed image thumbnail IM.

When the order information N is operated while the order information N is displayed in association with the printed image thumbnail IM, the order information N is hidden. The operation of the order information N is, for example, a tap operation. Accordingly, when an operation is performed on the order information N, the image data P corresponding to the printed image thumbnail IM associated therewith is brought into a non-selected state. For example, when an operation is performed on the second order information N2, the portable terminal 1 hides the operated second order information N2 and then displays the second order information N2 in association with the printed image thumbnail IM selected next. Additionally, when the second order information N2 and the third order information N3 are continuously operated, the portable terminal 1 hides the two pieces of order information N operated, and then displays the second order information N2 in association with the printed image thumbnail IM selected next and displays the third order information N3 in association with the printed image thumbnail IM selected thereafter. In addition, the portable terminal 1 may continuously receive operations on three or more pieces of order information N.

When the print button 56 is selected in the state illustrated in FIG. 10, the portable terminal 1 generates continuous print data such that the plurality of individual print images GP corresponding to the plurality of printed image thumbnails IM associated with the order information N are continuously printed in the print order indicated by the order information N, and transmits the generated continuous print data to the tape printing apparatus 2. That is, in the example illustrated in FIG. 10, the portable terminal 1 generates the continuous print data for printing the respective individual print images GP corresponding to the fourth printed image thumbnail IM4, the third printed image thumbnail IM3, the second printed image thumbnail IM2, and the first printed image thumbnail IM1 in this order.

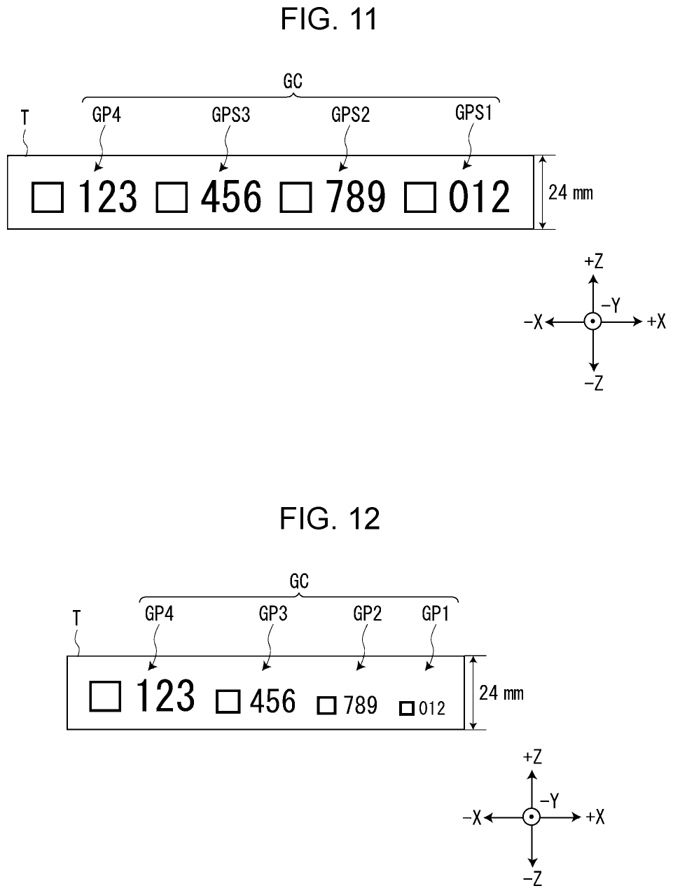

FIG. 11 illustrates a printed result of the continuous print image GC when the print button 56 is selected in the state illustrated in FIG. 10 and the automatic image resize function is set to valid. The example illustrated in FIG. 11 indicates the case where the continuous print image GC is printed on the tape T with a width of 24 mm. As illustrated in FIG. 11, the tape printing apparatus 2 continuously prints the fourth individual print image GP4 corresponding to the fourth printed image thumbnail IM4, the third individual print image GP3 corresponding to the third printed image thumbnail IM3, the second individual print image GP2 corresponding to the second printed image thumbnail IM2, and the first individual print image GP1 corresponding to the first printed image thumbnail IM1 in this order.

In addition, as described above, the portable terminal 1 converts the image data P with the corresponding tape width different from the printing tape width into the modified image data in which the image size is adjusted to match the printing tape width, and generates the continuous print data for printing the plurality of individual print images GP including the modified individual print image GPS corresponding to the modified image data. In the example illustrated in FIG. 11, the three individual print images GP other than the fourth individual print image GP4 are the modified individual print images GPS with an image size adjusted to match the printing tape width. That is, as illustrated in FIG. 10, in fourth additional information AD4 added to the fourth printed image thumbnail IM4, the corresponding tape width is 24 mm, which is the same as the printing tape width. In the respective pieces of additional information AD added to the other three printed image thumbnails IM, all the corresponding tape widths are less than the printing tape width. Therefore, as illustrated in FIG. 11, the three individual print images GP other than the fourth individual print image GP4 are the modified individual print images GPS with the image size enlarged to match the printing tape width.

FIG. 12 illustrates a printed result of the continuous print image GC when the print button 56 is selected in the state illustrated in FIG. 10 and the automatic image resize function is set to invalid. In this case, the portable terminal 1 generates the continuous print data without converting the image data P with the corresponding tape width different from the printing tape width into the modified image data. Therefore, in this case, the tape printing apparatus 2 prints the three individual print images GP other than the fourth individual print image GP4 while maintaining the image sizes of the respective pieces of corresponding image data P. In addition, the plurality of individual print images GP included in the continuous print image GC are printed with bottom alignment. That is, the plurality of individual print images GP included in the continuous print image GC are printed such that, when the individual print images GP are surrounded by rectangles each having two sides extending in the X-axis direction and two sides extending in the Z-axis direction, the side positioned in the −Z direction of the two sides extending in the X-axis direction has the same position in the Z-axis direction in each of the individual print images GP.

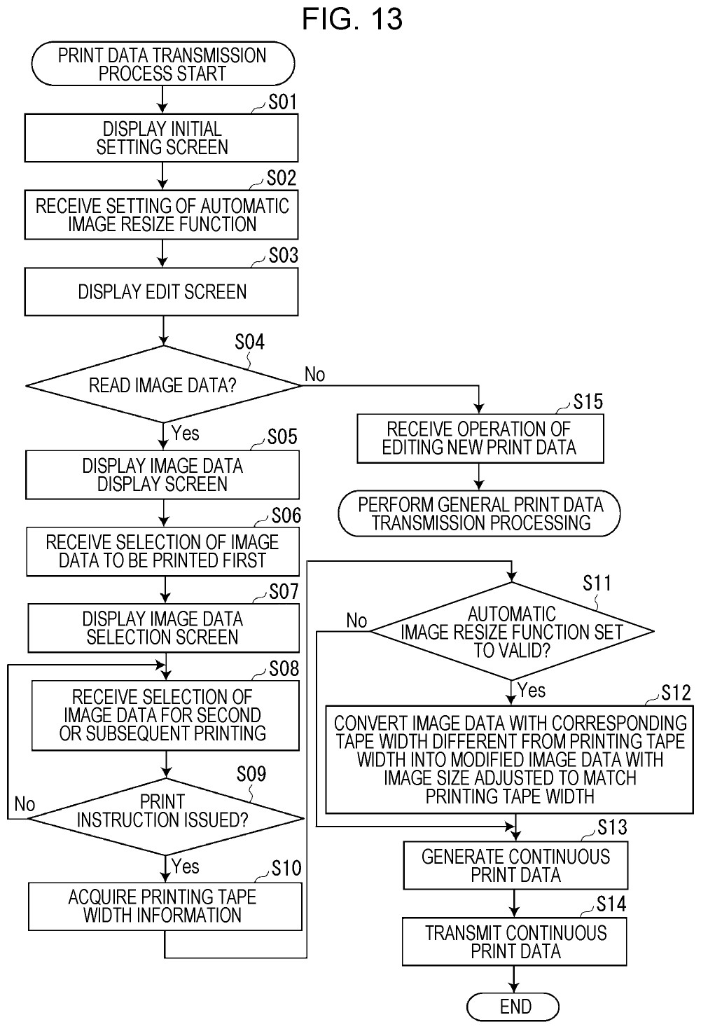

FIG. 13 is a flowchart illustrating a print data transmission process performed by the portable terminal 1. The print data transmission process starts when the dedicated application 31 is activated or when the user performs an initial setting start operation after the activation of the dedicated application 31. Additionally, in the print data transmission process illustrated in FIG. 13, continuous print data is transmitted in order to cause the tape printing apparatus 2 to perform continuous printing.

At step S01, the portable terminal 1 displays an initial setting screen (not illustrated) on the touch panel 11. On the initial setting screen, the automatic image resize function is set to either valid or invalid. In addition, for example, the tape printing apparatus 2 serving as a communication target is selected on the initial setting screen.

At step S02, the portable terminal 1 receives the setting of the automatic image resize function.

At step S03, the portable terminal 1 displays an edit screen (not illustrated). When the user performs an initial setting end operation on the initial setting screen, the portable terminal 1 displays the edit screen. On the edit screen, the print data is edited. Additionally, the edit screen includes a setting area (not illustrated), which allows selection of whether to newly edit the print data or to read and edit the image data P.

At step S04, the portable terminal 1 determines whether or not to read the image data P. That is, the portable terminal 1 determines whether or not the user has selected reading and editing the image data P in the setting area of the edit screen. If it is determined that the image data P is to be read, the portable terminal 1 proceeds to step S05. Alternatively, if it is determined that the image data P is not to be read, the portable terminal 1 proceeds to step S15.

At step S05, the portable terminal 1 displays the image data display screen D1 illustrated in FIG. 8. The portable terminal 1 displays a plurality of printed image thumbnails IM respectively corresponding to the plurality of pieces of image data P stored in the image data storage area 32 on the image data display screen D1.

At step S06, the portable terminal 1 receives selection of the image data P to be printed first. The user selects the image data P to be printed first by long pressing any one of the plurality of printed image thumbnails IM displayed on the image data display screen D1.

At step S07, the portable terminal 1 displays the image data selection screen D2 illustrated in FIG. 9. The portable terminal 1 displays, on the image data selection screen D2, the first order information N1 in association with the printed image thumbnail IM on which the selection operation has been performed at step S06.

At step S08, the portable terminal 1 receives selection of the image data P for the second or subsequent printing. The user selects the image data P for the second or subsequent printing by short pressing the printed image thumbnail IM on the image data selection screen D2.

At step S09, the portable terminal 1 determines whether or not a print instruction has been issued. That is, the portable terminal 1 determines whether or not the print button 56 has been selected on the image data selection screen D2. If it is determined that the print instruction has been issued, the portable terminal 1 proceeds to step S10. Alternatively, if it is determined that the print instruction has not been issued, the portable terminal 1 returns to step S08.

At step S10, the portable terminal 1 acquires the printing tape width information. The portable terminal 1 receives the cartridge information from the tape printing apparatus 2 by transmitting a cartridge information request signal to the tape printing apparatus 2, and acquires the printing tape width information included in the received cartridge information.

At step S11, the portable terminal 1 determines whether or not the automatic image resize function is set to valid. In accordance with the setting received at step S02, the portable terminal 1 determines whether or not the automatic image resize function is set to valid. If the portable terminal 1 determines that the automatic image resize function is set to valid, the portable terminal 1 proceeds to step S12. Alternatively, if the portable terminal 1 determines that the automatic image resize function is not set to valid, the portable terminal 1 proceeds to step S13.

At step S12, the portable terminal 1 converts the image data P with the corresponding tape width different from the printing tape width into modified image data in which the image size is adjusted to match the printing tape width.

At step S13, the portable terminal 1 generates continuous print data. If it is determined at step S11 that the automatic image resize function is set to valid, the portable terminal 1 generates the continuous print data based on a plurality of pieces of image data P including the modified image data. Alternatively, if it is determined at step S11 that the automatic image resize function is not set to valid, the portable terminal 1 generates the continuous print data based on a plurality of pieces of image data P that do not include the modified image data.

At step S14, the portable terminal 1 transmits the continuous print data generated at step S13 to the tape printing apparatus 2. After step S14, the portable terminal 1 terminates the print data transmission process.

At step S15, the portable terminal 1 receives an operation of editing new print data. The portable terminal 1 performs general print data transmission processing after receiving the operation of editing new print data.

As described above, when the automatic image resize function is set to valid, the portable terminal 1 according to the present embodiment converts the image data P with a corresponding tape width different from the printing tape width, among a plurality of pieces of image data P to be used for continuous printing, into modified image data in which the image size is adjusted to match the printing tape width. Therefore, even when a plurality of pieces of image data P with different corresponding tape widths are continuously printed, the portable terminal 1 may continuously print the individual print images GP having an image size adjusted to match the printing tape width.

In addition, the portable terminal 1 receives selection of a plurality of pieces of image data P to be used for continuous printing. This enables the user to select two or more pieces of image data P to be used for continuous printing.

In addition, the portable terminal 1 generates continuous print data so that the plurality of individual print images GP corresponding to the plurality of pieces of image data P are continuously printed in the order in which the selection of the image data P is received. This enables the user to select the printing order of the individual print images GP.

In addition, on the image data selection screen D2, the portable terminal 1 displays the order information N indicating the order in which the selection of the image data P is received, in association with the plurality of printed image thumbnails IM respectively corresponding to the plurality of pieces of image data P to be continuously printed. This enables the user to grasp the printing order of the individual print images GP.

In addition, the portable terminal 1 includes the terminal communicator 12 that communicates with the tape printing apparatus 2. Therefore, the portable terminal 1 may acquire the printing tape width information from the tape printing apparatus 2 via the terminal communicator 12.

The present disclosure is not limited to the above embodiments, and the following modifications may be adopted.

### First Modification

The receiving section 110 may receive selection of modification-unnecessary image data, which is the image data P for which it is unnecessary to adjust the image size to match the printing tape width, among the plurality of pieces of image data P to be printed continuously. In this case, the generator 140 generates the continuous print data based on the plurality of pieces of image data P including the modification-unnecessary image data in which the image size is not adjusted to match the printing tape width.

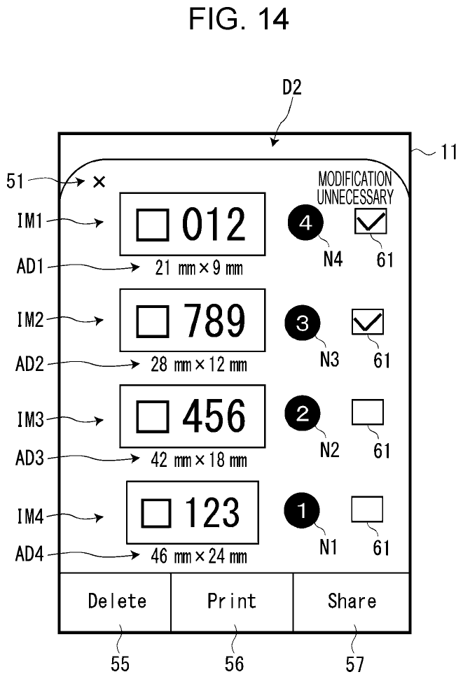

FIG. 14 illustrates an example of the image data selection screen D2 according to the present modification. In the image data selection screen D2 according to the present modification, a modification-unnecessary check field 61 is additionally displayed on the image data selection screen D2 illustrated in each of FIGS. 9 and 10. The modification-unnecessary check field 61 is used for selecting modification-unnecessary image data. In the example illustrated in FIG. 14, the modification-unnecessary check field 61 for the first and second printed image thumbnails IM1 and IM2 are checked. The first image data P1 and the second image data P2 respectively corresponding to the first and the second printed image thumbnails IM1 and IM2 are the modification-unnecessary image data. The image data selection screen D2 illustrated in FIG. 14 is a screen displayed when the automatic image resize function is set to valid. When the automatic image resize function is set to invalid, the image data selection screen D2 illustrated in each of FIGS. 9 and 10 is displayed.

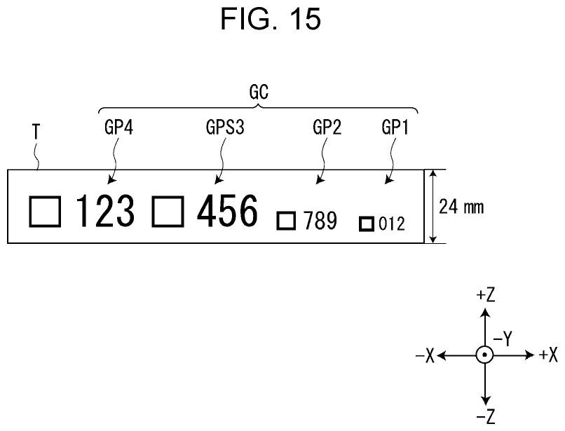

FIG. 15 illustrates a printed result when the tape T has a printing tape width of 24 mm and the print button 56 is selected in the state illustrated in FIG. 14. As illustrated in FIG. 15, the first individual print image GP1 and the second individual print image GP2 respectively corresponding to the first image data P1 and the second image data P2, which are modification-unnecessary image data, are printed at sizes that match the corresponding tape widths. Additionally, in the example illustrated in FIG. 15, since the tape T has a printing tape width of 24 mm, the fourth individual print image GP4 corresponding to the fourth image data P4 associated with the corresponding tape width of 24 mm is also printed at a size that remains in accordance with the corresponding tape width. As a result, only the third image data P3 among the first to fourth image data P1 to P4 is converted into the modified image data, and the third individual print image GPS3 is printed.

Accordingly, the portable terminal 1 according to the modification receives selection of the modification-unnecessary image data among the plurality of pieces of image data P to be used for continuous printing. This allows the user to select the modification-unnecessary image data.

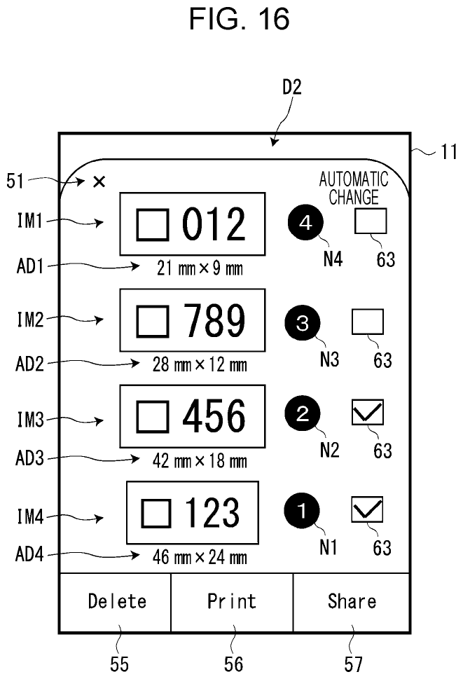

As a further modification, when the automatic image resize function is set to invalid, the image data selection screen D2 illustrated in FIG. 16 may be displayed. In the image data selection screen D2 illustrated in FIG. 16, automatic change check fields 63 are added to the image data selection screen D2 illustrated in FIGS. 9 and 10. The automatic change check field 63 is used to select the image data P to which the automatic image resize function is applied. In the example illustrated in FIG. 16, the automatic change check fields 63 for the third and fourth printed image thumbnails IM3 and IM4 are checked. The automatic image resize function is applied to the third image data P3 and the fourth image data P4 respectively corresponding to the third printed image thumbnail IM3 and the fourth printed image thumbnail IM4. Additionally, in the example illustrated in FIG. 16, the first image data P1 and the second image data P2 respectively corresponding to the first printed image thumbnail IM1 and the second printed image thumbnail IM2 are the modification-unnecessary image data. When the tape T has a printing tape width of 24 mm and the print button 56 is selected on the image data selection screen D2 illustrated in FIG. 16, the printed result illustrated in FIG. 15 is obtained.

### Second Modification

The acquirer 120 may acquire the printing tape width information before a print instruction is issued, rather than acquiring the printing tape width information when the print instruction is issued. For example, the acquirer 120 may acquire the printing tape width information when a predetermined trigger occurs, such as, when the dedicated application 31 is activated, when communication with the tape printing apparatus 2 is started, when an initial setting screen is displayed, or when an edit screen is displayed.

### Third Modification

The acquirer 120 may acquire the printing tape width information input by the user. The user may input the printing tape width information by using the touch panel 11. In this case, the touch panel 11 is an exemplary input section. The acquirer 120 may acquire, for example, the printing tape width information input to the initial setting screen. According to this configuration, the portable terminal 1 may acquire the printing tape width information input by the user. In addition, the user may set a desired tape width as the printing tape width.

### Fourth Modification

Upon receiving a cartridge information request signal from the portable terminal 1, the tape printing apparatus 2 may issue an error notification in the case where the cartridge type is not able to be detected by the cartridge information detector 42. Examples of the case where the cartridge type is not able to be detected include the case where the tape cartridge C is not mounted in the cartridge mounting portion 23 and the case where a detection error of the cartridge information detector 42 has occurred.

For example, the tape printing apparatus 2 may display, as the error notification, an error message indicating that the cartridge type is not able to be detected, on the printing apparatus display 22. Alternatively, the tape printing apparatus 2 may issue an error notification as the error notification to the portable terminal 1. In this case, the portable terminal 1 may display, on the touch panel 11, an error message indicating that the printing tape width information is not able to be acquired.

### Fifth Modification

The display controller 130 may receive, on the image data display screen D1, selection of the image data P to be used for continuous printing and display, on the image data selection screen D2, only one or more printed image thumbnails IM corresponding to the one or more pieces of image data P selected on the image data display screen D1.

### Sixth Modification

The receiving section 110 may receive selection of one or more pieces of non-target image data, which are not used for continuous printing, from among the plurality of pieces of image data P stored in the image data storage area 32. In this case, the generator 140 may generate the continuous print data such that, among the plurality of pieces of image data P stored in the image data storage area 32, the image data P other than the one or more pieces of non-target image data the selection of which has been received is to be used for the continuous printing.

### Seventh Modification

The portable terminal 1 may have a configuration in which selection of the image data P is not received by the receiving section 110. In this case, the generator 140 may generate the continuous print data such that the plurality of pieces of image data P stored in the image data storage area 32 are to be used for the continuous printing.

### Eighth Modification

If the acquired printing tape width information indicates a printing tape width that is not suitable for printing of the image data P selected to be used for continuous printing, the portable terminal 1 may issue a warning to the user. As the warning, the portable terminal 1 may display, on the touch panel 11, a warning message indicating that the printing tape width is not suitable for printing.

For example, when code image data for printing a two-dimensional code image is included in the image data P and the acquired printing tape width information indicates a tape width less than a specific tape width, the portable terminal 1 may issue a warning.

In addition, the portable terminal 1 may issue a warning when the image data P includes text image data for printing a plurality of lines of text and the tape width indicated by the acquired printing tape width information is a tape width that does not allow lines of the text included in the text image data to be printed. In this case, it is assumed that a correspondence table in which the printing tape width and the number of printable lines of the text are associated with each other is stored in the portable terminal 1. The portable terminal 1 may issue a warning when the number of lines of the text indicated by the text image data exceeds the number of printable lines associated with the tape width indicated by the acquired printing tape width information.

### Ninth Modification

The portable terminal 1 may issue a warning when the automatic image resize function is set to invalid and a plurality of pieces of image data P to be used for continuous printing include one or more pieces of image data P each associated with a corresponding tape width exceeding the printing tape width. In the above embodiments, with reference to FIG. 12, the case is described where the corresponding tape width less than or equal to the printing tape width is associated with each of the plurality of pieces of image data P to be used for continuous printing. If the automatic image resize function is set to invalid and the plurality of pieces of image data P to be used for continuous printing include one or more pieces of image data P each associated with a corresponding tape width exceeding the printing tape width, a portion in the +Z direction of the individual print image GP corresponding to the image data P is unlikely to be printed on the tape T.

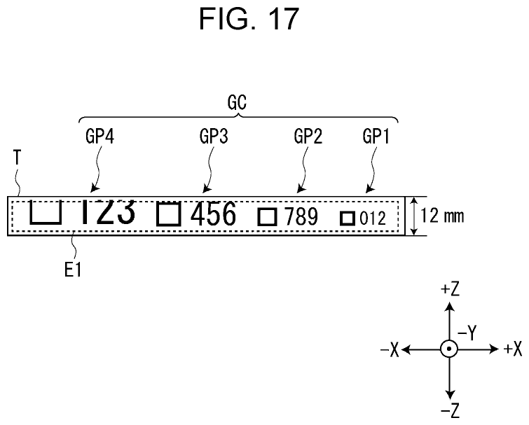

FIG. 17 illustrates a printed result when the continuous print image GC is printed on the tape T with a width of 12 mm under the same condition as in FIG. 12. In FIG. 17, a broken line frame indicates a printable region E1 in which printing with the print head 26 is possible. In the example illustrated in FIG. 17, since a portion in the +Z direction of the fourth individual print image GP4 corresponding to the fourth image data P4 associated with the corresponding tape width of 24 mm is not included in the printable area E1, not the whole of the fourth individual print image GP4 is printed. Accordingly, when the automatic image resize function is set to invalid and the image data P associated with the corresponding tape width exceeding the printing tape width is to be used for continuous printing, the individual print image GP corresponding to the image data P is likely to be printed in a partially missing state.

Therefore, the portable terminal 1 according to the present modification determines whether or not the automatic image resize function is set to invalid and one or more pieces of image data P each associated with the corresponding tape width exceeding the printing tape width are included in the plurality of pieces of image data P to be used for continuous printing. The portable terminal 1 makes this determination, for example, after step S11 in FIG. 13. If it is determined that one or more pieces of image data P associated with the corresponding tape width exceeding the printing tape width are included in the plurality of pieces of image data P to be used for continuous printing, the portable terminal 1 issues a warning. As the warning, the portable terminal 1 displays a warning message, on the touch panel 11, indicating that the print image G is unlikely to be printed appropriately. However, if it is determined that one or more pieces of image data P associated with the corresponding tape width exceeding the printing tape width are not included in the plurality of pieces of image data P to be used for continuous printing, the portable terminal 1 proceeds to step S12.

### Tenth Modification

The above embodiments may be applied to the tape printing apparatus 2. That is, the tape printing apparatus 2 may implement each function illustrated in FIG. 7. In the present modification, all the functions illustrated in FIG. 7 are implemented by the printing apparatus CPU 43a executing a control program stored in the printing apparatus ROM 43b.

### Eleventh Modification

The tape printing system SY may include an information processing terminal such as a personal computer (PC) instead of the portable terminal 1. Additionally, the image data P may be in another data format such as raster data rather than vector data. Additionally, the plurality of individual print images GP included in the continuous print image GC may be printed with top alignment or vertical center alignment, rather than bottom alignment.

Additionally, the dedicated application 31 may be provided as a program to the customer. Additionally, a storage medium in which the dedicated application 31 is recorded may be provided to the customer. In addition, appropriate changes may be made without departing from the gist of the present disclosure.

### Supplementary Note

Hereafter, an information processing apparatus, a method for controlling an information processing apparatus, and a storage medium will be additionally described.

The portable terminal 1 includes the acquirer 120 configured to acquire printing tape width information indicating a printing tape width that is a width of the tape T used in the tape printing apparatus 2; the image data storage area 32 storing a plurality of pieces of image data P for which respective corresponding tape widths are predefined; and the generator 140 configured to generate continuous print data for continuous printing of two or more individual print images GP respectively corresponding to two or more pieces of image data P, among the plurality of pieces of image data P stored in the image data storage area 32, on the tape T with the printing tape width indicated by the printing tape width information. When the corresponding tape width predefined for at least one piece of image data P among the two or more pieces of image data P to be used for the continuous printing differs from the printing tape width, the generator 140 is configured to convert the at least one piece of image data P with the corresponding tape width different from the printing tape width into modified image data in which an image size is adjusted to match the printing tape width, and to generate the continuous print data based on the two or more pieces of image data P including the modified image data.

The method for controlling portable terminal 1 is performed by the portable terminal 1. The method includes acquiring printing tape width information indicating a printing tape width that is a width of the tape T used in the tape printing apparatus 2, and generating continuous print data for continuous printing, on the tape T with the printing tape width indicated by the printing tape width information, of two or more individual print images GP respectively corresponding to two or more pieces of image data P among a plurality of pieces of image data P stored in the image data storage area 32 storing the plurality of pieces of image data P for which respective corresponding tape widths are predefined. The generating the continuous print data includes, when the corresponding tape width predefined for at least one piece of image data P among the two or more pieces of image data P to be used for the continuous printing differs from the printing tape width, converting the at least one piece of image data P with the corresponding tape width different from the printing tape width into modified image data in which an image size is adjusted to match the printing tape width, and generating the continuous print data based on the two or more pieces of image data P including the modified image data.

A non-transitory computer-readable storage medium storing a program that causes the portable terminal 1 to execute a process, the process including acquiring printing tape width information indicating a printing tape width that is a width of the tape T used in the tape printing apparatus 2, and generating continuous print data for continuous printing, on the tape T with the printing tape width indicated by the printing tape width information, of two or more individual print images GP respectively corresponding to two or more pieces of image data P among a plurality of pieces of image data P stored in the image data storage area 32 storing the plurality of pieces of image data P for which respective corresponding tape widths are predefined. The generating the continuous print data includes, when the corresponding tape width predefined for at least one piece of image data P, among the two or more pieces of image data P to be used for the continuous printing, differs from the printing tape width, converting the at least one piece of image data P with the corresponding tape width different from the printing tape width into modified image data in which an image size is adjusted to match the printing tape width, and generating the continuous print data based on the two or more pieces of image data P including the modified image data.

According to this configuration, even when two or more pieces of image data P with different corresponding tape widths are to be continuously printed, the portable terminal 1 may continuously print the individual print images GP having an image size adjusted to match the printing tape width.

It is preferable that the portable terminal 1 described above further include the receiving section 110 configured to receive selection of the two or more pieces of image data P to be used for the continuous printing from among the plurality of pieces of image data P stored in the image data storage area 32, and that, in the portable terminal 1 described above, the generator 140 is configured to generate the continuous print data based on the two or more pieces of image data P the selection of which is received by the receiving section 110.

According to this configuration, the user may select the two or more pieces of image data P to be used for continuous printing.

In the portable terminal 1 described above, it is preferable that the generator 140 be configured to generate the continuous print data such that the two or more individual print images GP corresponding to the two or more pieces of image data P are continuously printed in the order in which the selection of the two or more pieces of image data P is received by the receiving section 110.

According to this configuration, the user may select the printing order of the individual print images GP.

It is preferable that the portable terminal 1 described above further include the touch panel 11 and the display controller 130 that causes the touch panel 11 to display two or more printed image thumbnails IM respectively corresponding to two or more pieces of image data P to be used for the continuous printing, and that, in the portable terminal 1 described above, the display controller 130 cause the touch panel 11 to display the order information N indicating the order in which the selection of the two or more pieces of image data P is received by the receiving section 110 in association with each of the two or more printed image thumbnails IM.

According to this configuration, the user may grasp the printing order of the individual print images GP.

It is preferable that the portable terminal 1 described above further include the terminal communicator 12 configured to receive the printing tape width information transmitted from the tape printing apparatus 2, and that, in the portable terminal 1 described above, the acquirer 120 is configured to acquire the printing tape width information received by the terminal communicator 12.

According to this configuration, the portable terminal 1 may acquire the printing tape width information via the terminal communicator 12.

It is preferable that the portable terminal 1 described above further include the touch panel 11 through which the user inputs the printing tape width information, and that, in the portable terminal 1 described above, the acquirer 120 acquire the printing tape width information input through the touch panel 11.

According to this configuration, the portable terminal 1 may acquire the printing tape width information input by the user using the touch panel 11.

It is preferable that the portable terminal 1 described above further include the receiving section 110 configured to receive selection of modification-unnecessary image data that is, among the two or more pieces of image data P to be used for the continuous printing, the image data P for which it is unnecessary to adjust the image size to match the printing tape width, and that, in the portable terminal 1 described above, the generator 140 be configured to, when the selection of the modification-unnecessary image data is received by the receiving section 110, generate the continuous print data based on the two or more pieces of image data P including the modification-unnecessary image data in which the image size is not adjusted to match the printing tape width.

According to this configuration, the user may select the modification-unnecessary image data.

What is claimed is:

1. An information processing apparatus comprising:
an acquirer configured to acquire printing tape width information indicating a printing tape width that is a width of a tape used in a tape printing apparatus;
a storage storing a plurality of pieces of image data for which respective corresponding tape widths are predefined; and
a generator configured to generate continuous print data for continuous printing of two or more print images respectively corresponding to two or more pieces of image data, among the plurality of pieces of image data stored in the storage, on the tape with the printing tape width indicated by the printing tape width information, wherein
when the corresponding tape width predefined for at least one piece of image data among the two or more pieces of image data to be used for the continuous printing differs from the printing tape width, the generator is configured to convert the at least one piece of image data with the corresponding tape width different from the printing tape width into modified image data in which an image size is adjusted to match the printing tape width, and to generate the continuous print data based on the two or more pieces of image data including the modified image data.

2. The information processing apparatus according to claim 1, further comprising: a receiving section configured to receive selection of the two or more pieces of image data to be used for the continuous printing from among the plurality of pieces of image data stored in the storage, wherein
the generator is configured to generate the continuous print data based on the two or more pieces of image data the selection of which is received by the receiving section.

3. The information processing apparatus according to claim 2, wherein the generator is configured to generate the continuous print data such that the two or more print images corresponding to the two or more pieces of image data are continuously printed in an order in which the selection of the two or more pieces of image data is received by the receiving section.

4. The information processing apparatus according to claim 3, further comprising:
a display; and
a display controller configured to cause the display to display two or more printed image thumbnails respectively corresponding to the two or more pieces of image data to be used for the continuous printing, wherein
the display controller is configured to cause the display to display, in association with each of the two or more printed image thumbnails, order information indicating an order in which the selection of the two or more pieces of image data is received by the receiving section.

5. The information processing apparatus according to claim 1, further comprising a communicator configured to receive the printing tape width information transmitted from the tape printing apparatus, wherein
the acquirer is configured to acquire the printing tape width information received by the communicator.

6. The information processing apparatus according to claim 1, further comprising an input section through which a user inputs the printing tape width information, wherein
the acquirer is configured to acquire the printing tape width information input through the input section.

7. The information processing apparatus according to claim 1, further comprising:
a receiving section configured to receive selection of modification-unnecessary image data that is, among the two or more pieces of image data to be used for the continuous printing, the image data for which it is unnecessary to adjust the image size to match the printing tape width, wherein
the generator is configured to, when the selection of the modification-unnecessary image data is received by the receiving section, generate the continuous print data based on the two or more pieces of image data including the modification-unnecessary image data in which the image size is not adjusted to match the printing tape width.

8. A method for controlling an information processing apparatus, the method being performed by the information processing apparatus, the method comprising:
acquiring printing tape width information indicating a printing tape width that is a width of a tape used in the tape printing apparatus; and
generating continuous print data for continuous printing, on the tape with the printing tape width indicated by the printing tape width information, of two or more print images respectively corresponding to two or more pieces of image data among a plurality of pieces of image data stored in a storage storing the plurality of pieces of image data for which respective corresponding tape widths are predefined, wherein
the generating the continuous print data includes, when the corresponding tape width predefined for at least one piece of image data among the two or more pieces of image data to be used for the continuous printing differs from the printing tape width, converting the at least one piece of image data with the corresponding tape width different from the printing tape width into modified image data in which an image size is adjusted to match the printing tape width, and generating the continuous print data based on the two or more pieces of image data including the modified image data.

9. A non-transitory computer-readable storage medium storing a program that causes an information processing apparatus to execute a process, the process comprising:
acquiring printing tape width information indicating a printing tape width that is a width of a tape used in a tape printing apparatus; and
generating continuous print data for continuous printing, on the tape with the printing tape width indicated by the printing tape width information, of two or more print images respectively corresponding to two or more pieces of image data among a plurality of pieces of image data stored in a storage storing the plurality of pieces of image data for which respective corresponding tape widths are predefined, wherein
the generating the continuous print data includes, when the corresponding tape width predefined for at least one piece of image data, among the two or more pieces of image data to be used for the continuous printing, differs from the printing tape width, converting the at least one piece of image data with the corresponding tape width different from the printing tape width into modified image data in which an image size is adjusted to match the printing tape width, and generating the continuous print data based on the two or more pieces of image data including the modified image data.
